(19) United States
(12) Patent Application Publication
(10) Pub. No.: US 2026/0212280 A1
(43) Pub. Date: Jul. 23, 2026

(54) GEOTECHNICAL GROUND INFORMATION PREDICTION USING MACHINE LEARNING

(71) Applicant: FNV IP B.V., Leidschendam (NL)

(72) Inventors: Alexandre BOLEVE, Leidschendam (NL); Myrna STARING, Leidschendam (NL); Rod EDDIES, Leidschendam (NL)

(73) Assignee: FNV IP B.V., Leidschendam (NL)

(21) Appl. No.: 19/140,777

(22) PCT Filed: Dec. 19, 2023
(86) PCT No.: PCT/EP2023/086524

§ 371 Date: Jun. 18, 2025

(30) Foreign Application Priority Data
Dec. 23, 2022 (NL) 2033824

(51) Int. Cl. G06N 20/20; G01V 1/28; G01V 1/30

(52) U.S. Cl. CPC G06N 20/20; G01V 1/282; G01V 1/303

(57) ABSTRACT

A method of training a machine learning model to estimate geophysical information at a corresponding location is disclosed. The method comprises obtaining target data comprising geotechnical information and corresponding first locations and input data comprising geophysical information for corresponding second locations within a pre-defined region of each first location. The input data is applied to the machine learning model to obtain an output of the machine learning model and the parameters of the machine learning model are adjusted to reduce an error between the output of the machine learning model and the target data. A method of predicting geotechnical information using the trained model and a method of visualising predicted geotechnical information are also disclosed. The disclosure includes corresponding systems, computer readable media and machine learning models. Unlocking insights from Geo-Data, the present invention further relates to improvements in sustainability and environmental developments: together we create a safe and liveable world.

### TECHNICAL FIELD

This disclosure relates to methods and systems for analysing a target region beneath a surface of the earth. More particularly, the disclosure relates to a method and system for determining one or more geotechnical properties of the sub-surface target region. Unlocking insights from Geo-Data, the present invention further relates to improvements in sustainability and environmental developments: together we create a safe and liveable world.

### BACKGROUND

There is a general and ongoing need for systems and methods for determining sub-surface ground parameters. In particular, there is a need for systems and methods that can be used to model the properties of a target volume beneath the surface of the earth to provide the information useful for infrastructure planning. Determination of sub-surface ground properties during the early planning phase of construction projects reduces uncertainty during the location determination, foundation design, and construction phases of a project. This in turn reduces delays, overspend, and unnecessary use of material resources (e.g., concrete) during construction.

Geotechnical information describes ground parameters typically obtained using invasive techniques, for example cone pressure testing (CPT) to obtain information on soft ground, such as the pressure measured at an instrumented cone of the cone pressure testing apparatus, the analysis of drill cores to obtain geological composition information, such as the type or identity of subsurface rock or material, or the like. Geotechnical information is typically obtained by direct measurement or observation of geotechnical parameter(s).

Geophysical information describes ground parameters typically obtained using non-invasive techniques, for example by the analysis of surface waves or electrical resistivity tomography. Geophysical information is typically obtained by indirect measurement of the information in question, such as the wave velocity or resistivity at a particular location or volume of interest in the ground.

One key parameter for the determination of ground characteristics in a volume of interest is shear-modulus and shear-velocity Vs. The shear velocity Vs is the velocity at which a shear wave moves through the material and is controlled by the shear modulus of the material. The relationship between shear-velocity and shear modulus G is defined as the product of the shear modulus and the density of the material. Measurement of Vs therefore provides a valuable insight to the material properties of a sub-surface ground region.

Spectral analysis of surface waves (SASW) and multi-channel analysis of surface waves (MASW) are both examples of techniques for gathering surface wave information that can be used in the determination of material properties in a sub-surface volume. In both of these techniques, surface-level vibrations are measured, either from a passive source (vibrations in the surface as a result of ambient sources of noise) or an active source (e.g. a weight drop), and the dispersion of the resulting surface waves is studied. ReMi (Refraction Microtremor) is another surface-level technique that uses ambient noise and surface waves to infer material properties of a sub-surface region based on the observation of ambient noise at the surface.

Invasive techniques for measuring geotechnical information can often present logistical challenges, especially in urban or inaccessible environments, and are often prohibitively expensive. This is particularly problematic in situations where geotechnical information is to be mapped over an extended area, for example for visualising the geotechnical information.

### OVERVIEW

Based on the realisation that there exists a relationship between geotechnical and geophysical information that can be exploited to estimate geotechnical information without the need, or a reduced need, for invasive measurements, the disclosure provides a way of estimating geotechnical information from geophysical information, which can be used, for example, for visualising geotechnical information in a region of interest.

A method of training a machine learning model to estimate geophysical information at a corresponding location is disclosed. The method comprises obtaining target data comprising geotechnical information and corresponding first locations. The geotechnical information was obtained at the first locations using ground-penetrating apparatus. The method further comprises obtaining input data comprising geophysical information. The geophysical information was obtained using a ground surface technique for corresponding one or more second locations within a pre-defined region of each first location. The input data is applied to the machine learning model to obtain an output of the machine learning model and parameters of the machine learning model are adjusted to reduce an error between the output of the machine learning model and the target data.

The first and second locations may be defined in any suitable coordinate system, for example a two-dimensional coordinate system or a three-dimensional coordinate system. An example of the former is a slice of locations or volumes, including the first and second locations, with one dimension corresponding to a depth typically referred to as z in a cartesian coordinate system (e.g., measured relative to the ground or relative to sea level) and the other dimension corresponding to a direction generally along the surface of the ground or parallel to sea level, typically referred to as x in a cartesian coordinate system. An example of the latter adds to this a further dimension generally along the ground/sea level, typically referred to as y in a cartesian coordinate system. As an alternative to cartesian (x,z) or (x,y,z) coordinate systems, the locations may be specified in other coordinate systems, for example spherical or cylindrical coordinates. The geophysical information may be obtained by measurements that yield a 1-D or 2-D distribution of geophysical information and the distribution may then be located in the coordinate system of the geotechnical information, for example by defining the second locations in the same, for example 3-D, coordinate system as the first locations.

In some implementation, the input data further comprises a respective rate of change of the geophysical information with respect to depth for each second location. The rate of change may, for example, be the gradient (d/dz) relative to depth and may be calculated using discrete measurements at adjacent measurement location z1 and z2 as the difference of the geophysical information at depth z1 and z2 divided by the distance between z1 and z2.

Advantageously, it has been found in practice that adding a depth gradient/rate of change as an additional derived feature can improve the predicted estimate. It is believed that geophysical may vary smoothly and relatively slowly between geological components of the ground, so that the additional gradient feature accentuates transitions of the geophysical information between the geological components.

In some implementations each pre-defined region for the one or more second locations for each first location is defined in terms of maximum distance from the respective first location.

The first location may be, for example, from the location of maximum ground penetration of the cone in a CPT measurement or the location along a bore hole at which the geological information has been obtained from a drill core. In some implementations, the maximum distance may be taken relative to a longitudinal axis along which the respective geotechnical information was obtained, for example a bore or penetration hole made using ground-penetrating apparatus. In some specific implementations, each pre-defined region may be bounded by a distance of 3, 5 or 10, 20 or 30 meters from the respective first location. More complex regions for the second locations may be employed in some implementations. For example, the region to which the second locations may be limited may be defined as a cylinder portion with a radius corresponding to a maximum distance from a bore hole or CPT axis with a frustoconical top portion that slopes from the borehole or CPT cone or a minimum distance around the bore hole or CPT axis at ground level down to the cylindrical portion.

Advantageously, by limiting the volume of second locations around the first location, a trade-off between predictive power of data points and the number of available data points can be made. Including too remote second locations risks introducing noise, rather than signal, to the estimation, while limiting the second locations too closely reduces the available data and may lead to a risk of overfitting. The cut-off distance to be used will depend on the circumstances, including the specific geotechnical and geophysical information involved and the specific composition of the site in question. As a general rule, a distance of 3 or 5 meters has been found to be suitable in many contexts.

In accordance with some disclosed implementations, the geophysical information for each second location may be weighted with a weight, which decreases with a distance of the second location from the respective first location, for example a distance as described above for the maximum distance, or with a distance from a longitudinal axis along which the respective geotechnical information was obtained, for example as described above. In some implementations, the weight decreases from a value of 1 at the first location to a value 0.25\hat{ }2 at or above a maximum distance from the first location. The weight may decrease, for example, as a function of the squared inverse of the distance.

Advantageously, in addition to or instead of a distance cut-off, inversely weighing the geophysical information with respect to the distance between the corresponding first and second locations weighs the geophysical information by its likely predictive power for the geotechnical information at the first location, which may allow a larger volume of second locations to be used for prediction while managing the addition of noise from more remote locations. The weight may be applied to each instance of input data/geophysical information to alter the influence the instance has on adapting the parameters of the training model (the weights weigh the contribution of each instance of data to the criterion used to adjust the parameters). For example, in the case of a regression model minimising squared error, the each weight may be multiplied with the residual between the respective model output and the corresponding target data when calculating the squared error.

Further disclosed is an estimation method of obtaining an estimate of geotechnical information at a corresponding first location using a machine learning model trained as described above. The estimation method comprises obtaining input data comprising geophysical information for the first location and applying the input data to the machine learning model to obtain an output of the machine learning as the estimate.

Advantageously, by using geophysical information, which can be obtained non-invasively from surface measurements, to estimate geotechnical information that typically requires direct invasive measurements, such as a bore hole or cone penetration, geotechnical data can be obtained without the expense of carrying out invasive measurements. The machine learning model may be used to “fill in” estimated geotechnical information in between actual measurement sites, for example to provide more complete or higher resolution visualisations. The model may be updated in case further geotechnical information becomes available for a given site, to fine tune the model for the given site. In some instances, the need for geotechnical information can be dispensed with once the model has been trained.

The disclosure also includes a visualisation method of visualising geophysical information at a plurality of locations. The visualisation method comprises obtaining a respective estimate of the geotechnical information at each of the plurality of locations, for example at regularly spaced locations within a volume to be sampled, using the estimation method described above, and providing an output, for example a data file, image file, 2D or 3D model, display signal or display, visualising the geotechnical information at the plurality of locations. The visualisation may be configured to visualise the geotechnical information in the same coordinate system as the first locations or may be configured to use a different coordinate system. Visualisation may be in three-dimensions, with the estimated geotechnical information being estimated for each of a plurality of voxels or unit volumes inside a visualised volume pertaining to a given site. Visualisation may be in two dimensions in some implementations, for example visualising the geotechnical information along a ground surfaces or within a slice including a depth direction.

The geophysical information may comprise, in some implementations, a value of shear wave velocity Vs for each second location. In some implementations, the geophysical information, Vs or otherwise, was obtained from measurements of surface waves at a plurality of locations. The measurements may have been obtained using receivers located at or near a surface of the earth, such as geophones, for example. In some implementations, the measured surface waves are passive surface waves. In these implementations, measurements can be obtained without an active seismic source. In some implementations, the geophysical information can comprise other quantities and measurement, for example for example seismic refraction, electrical resistivity or induced polarisation. Some measurements may be obtained using electrical resistivity tomography. Techniques used for acquiring geophysical information may include SASW, MASW and ReMi in corresponding implementations.

In some implementations, the geotechnical information may be CPT data, such as cone resistance. More generally, in some implementations, the geotechnical information may comprise at least one of cone resistance, cone wall friction and ground water pressure relative to the respective first location or other CPT measurements. In some implementations, the geotechnical information comprises, alternatively or additionally, at least one of ground type or lithology.

It will be appreciated that the disclosure is not limited to any particular machine learning technique and that any machine learning model or function approximation technique capable of capturing a relationship between the geophysical and geotechnical information to a desired degree of accuracy and/or complexity, for example, can be used. In some specific implementations, the machine learning model may comprise one or more decision tree models. For example, the machine learning model may be a random forest regressor model or a random forest classifier model in case of categorical geotechnical information. In this example, the parameters to be adjusted may comprise the split parameters of each node (the split threshold and corresponding input dimension in case of multi-dimensional input) for each tree of the random forest and the parameters may be adjusted in a greedy way node by node to reduce the error, for example adjusting the split parameters to minimise a splitting criterion, such as, in the case of a regression model, the sum of squared (or absolute) residuals between the average output value of each child node of the split and the actual output value of the data points in each child node of the split. Decision trees may be trained in a non-greedy way or may be pruned after greedy training.

Training the machine learning model may further comprise tuning hyperparameters in addition to adjusting the model parameters. In the case of a random forest model, these hyperparameters may include, for example, a maximum tree depth, a minimum number of samples in a node for it to be split, a maximum leaf number, a minimum number of samples in a leaf after splitting, a number of trees in the forest, a maximum number of features/input dimensions for each tree, a maximum number of samples for each tree, whether data is sampled with or without replacement and a split criterion. The split criterion may be, for example, mean squared error or mean absolute error for a random forest regressor predicting a numerical value of the geotechnical information, such as cone pressure. For a random forest classifier predicting a categorical value of the geotechnical information, such as geological composition information, the split criterion may be gini or entropy/information gain, for example.

Other models may be used in implementations of the disclosure, as a function of the desired complexity, the availability and type of data, and computational resources, for example. Suitable machine learning models may include neural networks, for example any deep learning model or architecture. Suitable machine learning models may, in some circumstances, include linear or non-linear regression models.

Training the machine learning model may, in some implementations, involve pre-processing the input and/or target data. For example, each feature (or dimension) of the input data (geophysical information) and/or target data (geotechnical information) may be normalised to be zero-mean and/or standardised to have unity variance.

The disclosure extends to a system comprising one or more processors and one or more memories storing computer readable instructions. The instructions are configured to cause the one or more processors to perform operations comprising the steps described above. The disclosure further extends to one or more computer readable media comprising instructions, that, when executed by at least one data processing apparatus, cause the at least one data processing apparatus to perform operations comprising the steps described above. Also disclosed is a machine learning model trained as described above and, in some implementations, stored on one or more computer readable media.

### BRIEF DESCRIPTION OF THE DRAWINGS

Disclosed implementations will now be described by way of example to illustrate aspects of the disclosure and with reference to the accompanying drawings, in which:

FIG. 1 shows a method of training a machine learning model to estimate geotechnical information;

FIGS. 2A-C show a scheme for defining a data region for use in training the machine learning model and FIG. 2D shows a sample weighting scheme;

FIG. 3 shows a method of estimating geotechnical information;

FIG. 4 shows a method of visualising estimated geotechnical information;

FIG. 5 shows a visualisation generated using the method of FIG. 4; and

FIG. 6 shows a computer system for implementing the disclosed methods.

### DETAILED DESCRIPTION

Geophysical information that can be measured using non-invasive geophysical techniques is known to be related to geotechnical information that is typically measured using invasive techniques, such a drilling holes in the grounds, driving a cone into the ground or obtaining ground samples. Geophysical information includes seismic refraction, shear wave velocity Vs, electrical resistivity p and induced polarisation. For example, shear wave velocity in a sub-surface volume can be derived from surface waves using techniques like MASW. 1D MASW produces a depth profile at a geophone measurement point and 2D MASW produces a depths profile along a surface line of measurement points. 3D Vs data can be generated from either from a combination of 1D and/or 2D profiles or using a 2D surface array of measurement points to give 3D voxels of Vs values. Electrical resistivity ρ data can be derived, for example, using Electrical Resistivity Tomography (ERT).

Different types of geophysical information are known to be related to different types of geotechnical information in the sense that knowledge of the geophysical values can be used to derive information about geotechnical information, for example because different aspects of geotechnical information relate to different aspects of geophysical information. For example, some geophysical information quantities and related geotechnical information quantities are set out in the following table:

| Geophysical | Seismic | Shear wave | Electrical | Induced |
|---|---|---|---|---|
| information | refraction Vp | velocity Vs | resistivity ρ | polarisation IP |
| Related | Geological | Geological | Geological | Permeability |
| geotechnical | samples | samples | samples | Electrical |
| information | (lithology) | (lithology) | (lithology) | resistivity/ |
| | Ground type | Ground type | Porosity | conductivity |
| | Soil type | Soil type | Ground type | Oxygen and |
| | Cone resistance | Cone resistance | Radioisotope | oxidation |
| | | Pressure meter | Electrical | reduction |
| | | | resistivity/ | potential |
| | | | conductivity | |
| | | | Water samples | |

In implementations of the present disclosure, individual ones or combinations of the above geophysical information types are used to estimate geotechnical information, including those pairings set out in the above table. In addition, in some implementations, one or more derived quantities of the geophysical information are used individually or in combination with geophysical quantities. In some implementations, a derive quantity is the gradient of a corresponding geophysical information, for example the depth gradient of Vs, defined as dVs/dz or (Vs(z2)−Vs(z1))/(z2−z1). It will be understood that the term geophysical information includes the original quantities and any applicable derived quantities.

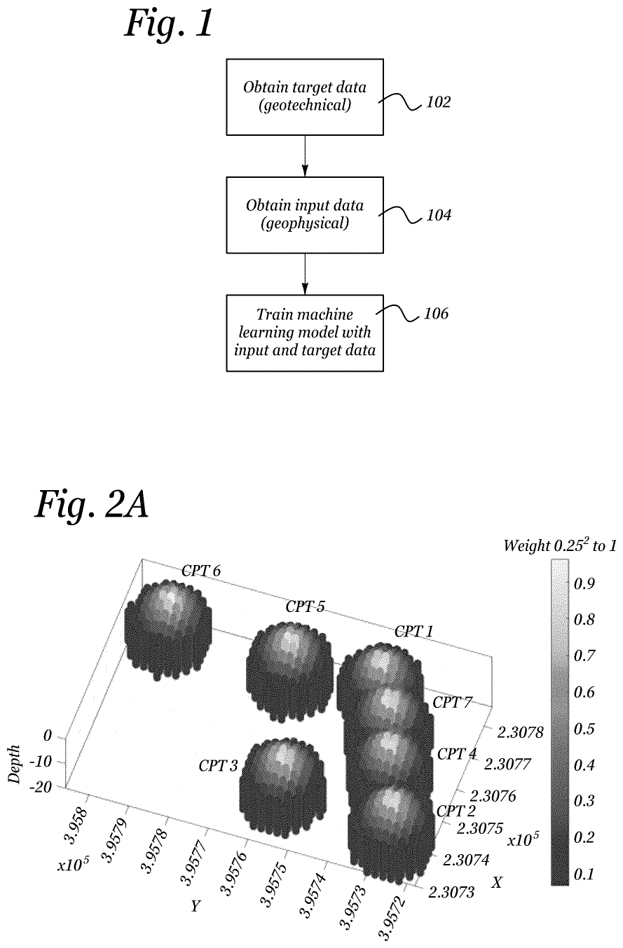

With reference to FIG. 1, a machine learning process obtains pairs of geotechnical information and geophysical information as pairs of target data and input data for the machine learning model by obtaining the target data at step 102 and obtaining the input data at step 104, for example by accessing a database where previously measured/calculated data has been stored. The input data may contain instance of different types of geophysical information as input features. The target data and each input feature are normalised and standardised. Each pair of target and input data comprises target data at a particular location where target data was measured by a geotechnical method and one or more instances of input data obtained with a geophysical method at locations within a pre-defined region relative to the location of the target data. Thus, several pairs of target and input data may have the same instance of target data but different instance of input data.

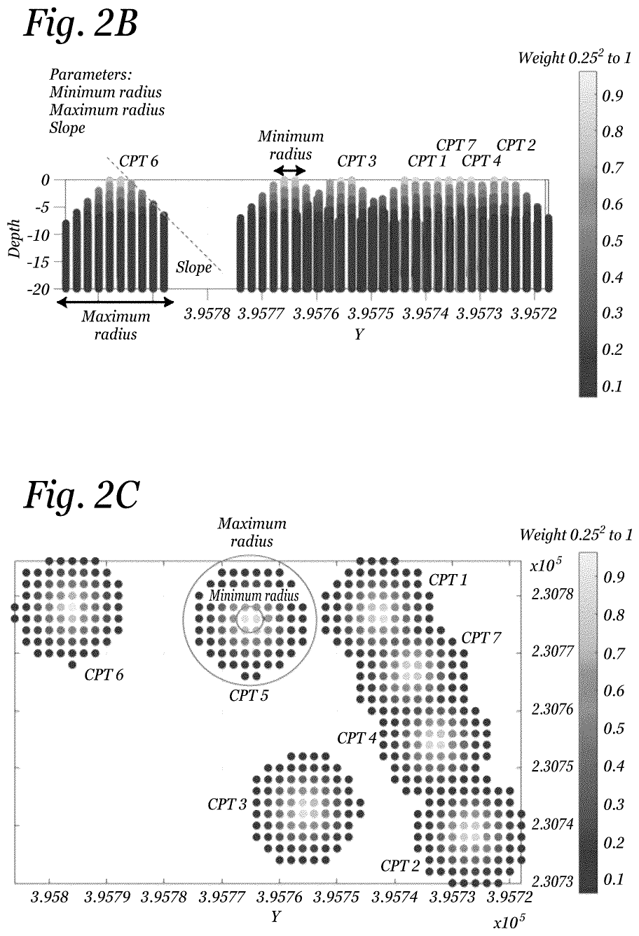

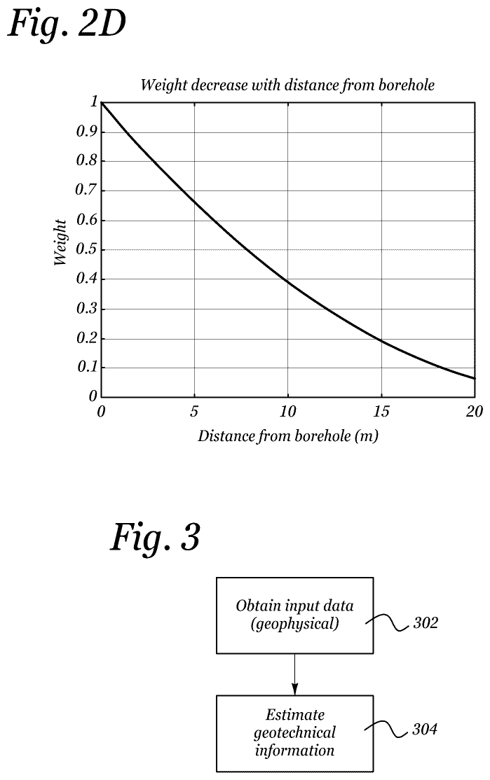

FIG. 2A-C illustrate a perspective, plan and elevation view of an example of a predefined region, in this case an annular cylinder bound by a radius from a depth axis of a measurement site for the geotechnical measurement with a top portion that slopes towards the surface of the ground and forms a minimum radius from the depth axis at the surface. In addition, in some implementations, each pair of target and input data is associated with a weight that determines how much each pair of target and input data influences the machine learning model in the training process. The weight decreases with a distance between the respective locations for which the target and input data were obtained, so that pairs for which the locations are closer influence the training process more. In some specific implementations, the weight varies as the inverse of the squared distance from unity at the location of the target data to a value of 0.25\hat{ }2 for a distance of 20 metres. The dependency of the weight on distance is illustrated in FIG. 2D.

Returning to FIG. 1, the input and target data is used to train the machine learning model at step 106, as is well known. Input data is applied to the model as inputs and the model outputs are compared to the target data. Model parameters are adjusted to reduce an error between the model outputs and target data and the process is repeated until a good enough model is obtained as measured by a stopping criterion, for example a convergence criterion, a criterion on the error or a pre-set number of epochs. Numerous programming languages and libraries are available to implement a large variety of machine learning models. The skilled person choses a suitable model based on considerations such as available data and compute and the kind of data to be processed based on routine considerations. In some specific implementations, the machine learning model is a random forest (RF) regressor for applications in which the geotechnical information is numerical or a RF classifier for applications in which the geotechnical information is categorical. In some implementations, the RF regressor is implemented using Python® and the Sci-kit® library scikit-learn, specifically using the .fit method of an instance of the sklearn.ensemble.RandomForestRegressor (or sklearn.ensemble.RandomForestClassifier, as the case may be) class. In some the RF regressor is trained with hyperparameters set to their default values, apart from the number of trees in the forest, which is set using cross-validation, for example to one of 100, 200 or 300 trees. The size of training data sets can vary significantly from one application to the next and depends on the area covered, the number of dimensions in the input data (geophysical features), the number of geotechnical measurement sites, the resolution and dimensionality of the geophysical data and so forth. For example, in simple applications involving one line of geophysical 2D data for a single geophysical feature and 1 or 2 boreholes or CPT sites, data sets may be as small as 100 samples. In more involved applications, for example involving 3 or 4 geophysical features covering a 3D volume under a surface of, say, 500 m×500 m and around 10 to some tens of CPT or borehole sites spaced 10 m-50 m apart, data sets may include about 10000 samples or so.

In one example, a RF regressor is trained using training data sets for different combinations of shear wave velocity Vs obtained as 3-D data from several 2-D MASW field acquisitions and resistivity ρ obtained from ERT field acquisitions, as well as derived quantities including the logarithm log(ρ) and the depth gradient Grad(Vs) and Grad(ρ), for pre-defined regions as described above with respective largest radii of 5 m and 3 m. The predicted geotechnical information is cone resistance in units of pressure measured using CPT. The smaller radius consistently results in lower regression scores and the regression score for the 3 m radius divided by the number of features in the input data is reported. Regression scores are calculated on a test portion, for example 20%, of the data set on which the RF regressor is not trained.

| | | | Regression |
|---|---|---|---|
| | Radius/Regression score | | score (3 m)/ |
| Features | 5 m | 3 m | per feature |
| Vs | 139 | 183 | 183 |
| ρ | 31 | 92 | 92 |
| Log(ρ) | 6 | 5 | 5 |
| Grad(ρ) | 30 | 54 | 54 |
| Grad(Vs) | 26 | 79 | 79 |
| Vs + ρ | 659 | 787 | *394 |
| ρ + Grad(ρ) | 260 | 454 | 227 |
| Vs + Grad(Vs) | 768 | 881 | **441 |
| Grad(ρ) + Grad(Vs) | 259 | 477 | 239 |
| ρ + Grad(Vs) | 489 | 735 | 368 |
| Vs + Grad(ρ) | 433 | 562 | 281 |
| ρ + Vs + Grad(ρ) | 916 | 939 | 313 |
| ρ + Vs + Grad(Vs) | 969 | 986 | 329 |
| ρ + Vs + Grad(ρ) + Grad(Vs) | 988 | 992 | 248 |

As can be seen, a combination of Vs and Grad(Vs) provides the best (**) regression score per feature, with the runner up (*) being a combination of Vs and p. The results indicate that many different combinations of geophysical information features and/or their derived features can provide predictions of CPT cone resistance.

With reference to FIG. 3, an estimation process comprises obtaining, at step 302, input data, which may or may not previously have been used for model training but is arranged in the same way as described above for model training. In the former case, the model can be seen as assisting data integration between different modalities and to fill in geotechnical information in between sites at which geotechnical information has been measured (data integration) and in the latter case, the estimation may provide new estimates of new geotechnical information in regions where only geophysical information is available. At step 304, an output of the model in response to the input data is obtained and used as an estimate for geotechnical information at a corresponding estimate location. In order to obtain the estimate at the estimate location, in some implementations, the input data is obtained at an input location as close as possible to the estimate location. For example, the input data may be available on a regular grid in a 3D coordinate system. To provide an estimate at the estimate location, then, the input data at the grid-point closest to the estimate location is used in some implementations. In some implementations, the estimate location is the same as the location of the respective input data, e.g. on the grid points on which the input data is defined. Thus, estimation and input locations may coincide, for example at the same grid point. In some implementations using a machine learning model trained with the .fit method of an instance of the sklearn.ensemble.RandomForestRegressor (or sklearn.ensemble.RandomForestClassifier, as the case may be) class, the .predict method of that instance may be used to obtain the prediction.

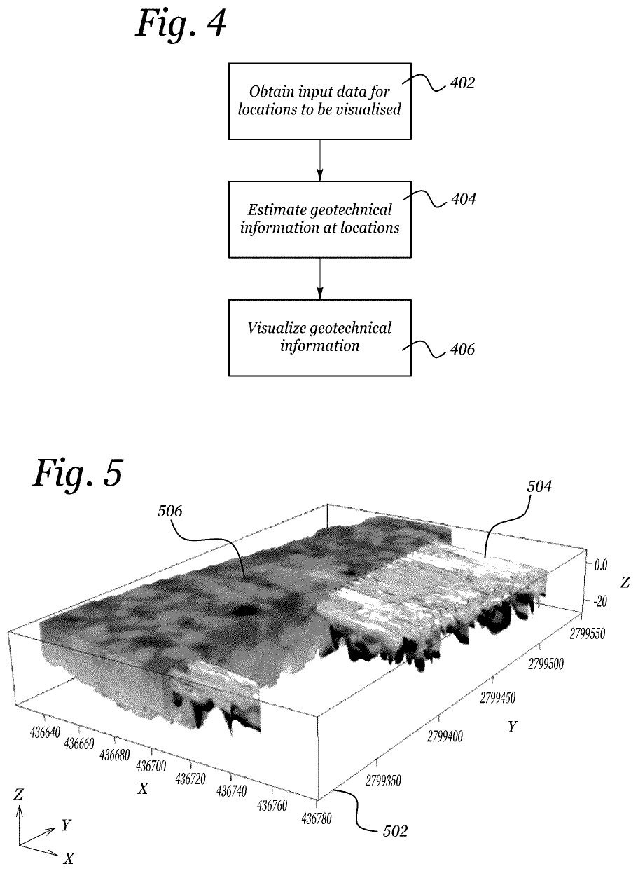

With reference to FIG. 4, a process for visualising estimated geotechnical information at estimation locations to be visualised comprises obtaining, at step 402, input data at input locations for each estimate location is obtained as described above with reference to FIG. 3. The geotechnical information is estimated at step 404 as described above and is visualised at step 406. For example, estimated geotechnical information may be obtained for estimation locations on grid points of a grid in a 3D coordinate system, for example defining voxels of geotechnical information. Visualising, in some implementations, comprises rendering a corresponding 3D model visualising the estimated geotechnical information. Visualising may comprise outputting the rendered model, for example in the form of a data file, image file, 2D or 3D model, display signal, printout, or display. Visualisation may also comprise 3D model slices views (vertical, horizontal or any orientation of 2D slices view from a set of 3D voxel) and/or a voxel data selection view (for example only displaying voxels with a value between a minimum and a maximum value).

An example visualisation is illustrated in FIG. 5, showing a coordinate system 502 in which Vs input data 504 derived from 2D MASW can be seen (the line scan structure of the 2D MASW data is apparent), and corresponding estimates 506 of cone pressure from CPT obtained as described above are visualized by pseudo-colour. The visualization of the estimates is removed in a portion of the visualized volume to reveal the visualized input data in the removed portion in the same coordinate system.

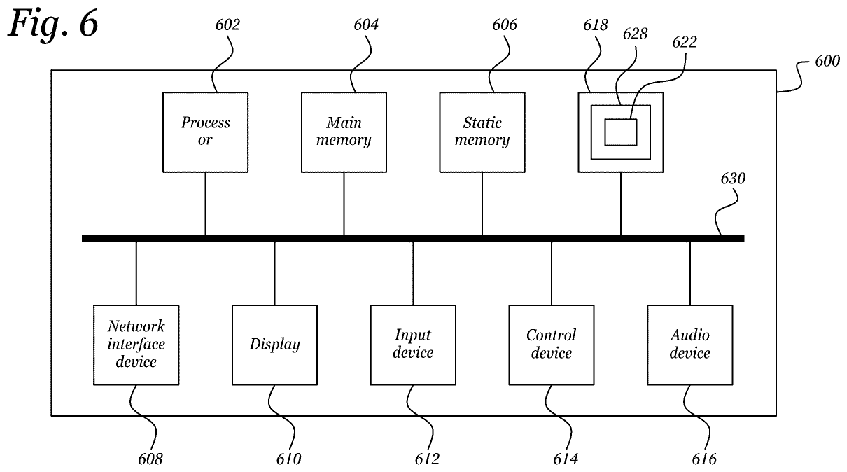

FIG. 6 shows a block diagram of one implementation of a computing device 600 within which a set of instructions, for causing the computing device to perform any one or more of the methodologies discussed herein, may be executed. In alternative implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example computing device 600 includes a processor 602, a main memory 604 (e.g., read-only memory (ROM), flash memory, dynamic random-access memory (DRAM) such as synchronous DRAM (SDRAM) or Rambus DRAM (RDRAM), etc.), a static memory 606 (e.g., flash memory, static random-access memory (SRAM), etc.), and a secondary memory (e.g., a data storage device 618), which communicate with each other via a bus 630.

Processor 602 represents one or more general-purpose processors such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 602 may also be one or more special-purpose processors such as an application specific integrated circuit (ASIC), a field programmable gate array (FPGA), a digital signal processor (DSP), network processor, or the like. Processor 602 is configured to execute the processing logic (instructions 622) for performing the operations and steps discussed herein.

The computing device 600 may further include a network interface device 608. The computing device 600 also may include a video display unit 610 (e.g., a liquid crystal display (LCD) or a cathode ray tube (CRT)), an alphanumeric input device 612 (e.g., a keyboard or touchscreen), a cursor control device 614 (e.g., a mouse or touchscreen), and an audio device 616 (e.g., a speaker).

It will be apparent that some features of computer device 600 shown in FIG. 6 may be absent. For example, one or more computing devices 600 may have no need for display device 610 (or any associated adapters). This may be the case, for example, for particular server-side computer apparatuses 600 which are used only for their processing capabilities and do not need to display information to users. Similarly, user input device 612 may not be required. In its simplest form, computer device 600 comprises processor 602 and memory 604.

The data storage device 618 may include one or more machine-readable storage media (or more specifically one or more non-transitory computer-readable storage media) 628 on which is stored one or more sets of instructions 622 embodying any one or more of the methodologies or functions described herein. The instructions 622 may also reside, completely or at least partially, within the main memory 604 and/or within the processor 602 during execution thereof by the computer system 600, the main memory 604 and the processor 602 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid-state memory, magnetic tape, a removable computer diskette, a random-access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein. In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the above discussion, it is appreciated that throughout the description, discussions utilizing terms such as “receiving”, “determining”, “comparing”, “enabling”, “maintaining,” “identifying”, “obtaining”, “applying”, “adjusting”, and the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosure includes using a machine learning model that uses geophysical information to predict geophysical information. The machine learning model maps an input representing an instance of geophysical information to a corresponding prediction of geophysical information. Each input may be a numeric representation of a data point, or may be a set of one or more features describing the data point. The features may be numeric features and/or categorical features, depending on the model. Categorical features may be encoded in a numeric representation, for example using one-hot encoding. The prediction of geophysical information may be represented by one or more numeric or categorical variable. For example, where the prediction of geophysical information is a binary classification of the corresponding instance of geotechnical information into one of two classes, the output may correspond to a numeric indicator of which class the instance belongs to, that can be thresholded to output a class indication. Similarly, in a multiclass problem, the output may be a set of numeric indicators that each indicates a class belonging score for a respective class and that can be compared to determine a class of the instance of geophysical information. In some implementations, the prediction comprises one or more numeric variable that can take continuous values representing a property of the instance of geophysical information, so that the model performs a regression of geophysical information against geophysical information.

The machine learning model may be a linear regression model, a logistic regression model, a support vector machine, a decision tree, an ensemble model such a random forest or a boosted decision tree, or a neural network. A neural network comprises of a plurality of interconnected units, often referred to as neurons, that are organised in layers. A neural network has an input layer of one or more input neurons that receive a numeric representation of an instance of geophysical information, one or more hidden layer of neurons connected to the neurons of the input layer and an output layer of one or more output neurons connected the neurons of the hidden layer to produce an output that represents and instance of geophysical information corresponding to the instance of geophysical information. A neural network having two or more hidden layers is often referred to as a deep neural network. Each neuron holds a numeric value (for example the numeric representation of the input in case of input neurons), referred to as activation. The neuron activations are propagated from the input layer to the output layer via the one or more hidden layers. This is done by each neuron in a given layer summing the activations of one or more neurons in a previous layer, each activations being weighted by a respective connection weight. The sum is passed through a function known as an activation function to provide an output for the neuron in question that is passed to the next layer, and so on. The activation function is typically a non-linear function, for example a rectified linear function (ReLU) or a leaky rectified linear function, or a sigmoid, tanh or other non-linear function. Output neurons for multi-class problems often may use a softmax function.

The machine learning model has parameters and may have hyper-parameters that define the machine learning model. Hyper-parameters define the structure of the machine learning model. Parameters define how the model maps from inputs to outputs and are learned from training data, that is the parameters are adjusted during a training phase in which the hyper-parameters are held fixed. The hyper parameters may be set based on experience and are often tuned by comparing multiple training runs with different hyperparameters, although in some cases they are simply held fixed. The training data comprises pairs of input data representing instances of geophysical information and actual data representing instances of geophysical information.

Training the machine learning model comprises adjusting the parameters of the model to reduce an error between the prediction of the model and the actual data representing geophysical information. This is done by repeatedly presenting the model with the training data over several epochs and adjusting the parameters until a stopping criterion is met, for example a fixed number of epochs or the error dropping below a threshold or converging to a constant level. The parameters can be adjusted using any suitable optimisation technique, for example stochastic gradient descent. In the case of a neural network, the connection weights are the parameters being tuned in each training run and the hyperparameters may include such things as the number of layers, the neurons in each layer, the activation function(s) used, how the connections are organised, and so forth. Models based on decision trees may be learned greedily splitting the tree one node at a time based on a criterion function. Some of the structure of the model may be fixed and some may be defined and tuned using hyper parameters. Of course, the model may be entirely fixed so that there are no hyperparameters.

The data available to train may be split two or three way to train the model and evaluate its performance. The bulk of the data is used as the training set to adjust the model parameters for each setting of the hyper parameters. Some data is held back to test the performance of the model once it has been trained, as doing so on the training data would give a biased view of model performance. This data is referred to as test data. Where several models are trained using different settings of the hyper parameters, an additional portion of the data set may be held back as a validation data set that is used to test the performance of each of these models to select a setting of the hyper-parameters. The test data may then be used to evaluate the performance of the model with the selected setting of the hyper-parameters.

Once the model has been trained, it can be used to predict geotechnical information for a new instance of geophysical information not part of the training, test or validation data in a process typically referred to as inference. An instance of geophysical information is applied to the model as an input and a prediction geophysical information is obtained as the output. The prediction may then be used directly or be subject to post-processing and the post-processed prediction be used.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A method of training a machine learning model to estimate geotechnical information at a corresponding location, the method comprising:
obtaining target data comprising geotechnical information and corresponding first locations at which the geotechnical information was obtained, wherein the geotechnical information was obtained using ground-penetrating apparatus;
obtaining input data comprising geophysical information for corresponding one or more second locations within a pre-defined region of each first location, wherein the geophysical information was obtained using a ground surface technique;
applying the input data to the machine learning model to obtain an output of the machine learning model; and
adjusting parameters of the machine learning model to reduce an error between the output of the machine learning model and the target data.

2. The method of claim 1, wherein the input data further comprises a respective rate of change of the geophysical information with respect to depth for each of the corresponding one or more second locations.

3. The method of claim 1, wherein each pre-defined region is defined in terms of maximum distance from a respective first location or maximum distance from a longitudinal axis along which the geotechnical information was obtained at the respective first location.

4. The method of claim 1, wherein the geophysical information for each of the corresponding one or more second locations is weighted with a weight, the weight being determined to decrease with a distance of a respective second location from a respective first location or with a distance from a longitudinal axis along which respective geotechnical information was obtained.

5. The method of claim 1, further comprising:
obtaining an estimate of the geotechnical information at the corresponding first locations using the machine learning model;
obtaining the input data comprising the geophysical information for the corresponding first locations; and
applying the input data to the machine learning model to obtain an output of the machine learning model as the estimate.

6. The method of claim 5, wherein the output is at least one of:
a data file, image file, 2D or 3D model, display signal or display, visualising the geotechnical information.

7. The method of claim 6, wherein the geophysical information comprises a value of shear wave velocity for each second location.

8. The method of claim 6, wherein the geophysical information was obtained from measurements of surface waves at a plurality of locations, for example using receivers located at or near a surface of earth, such as geophones.

9. The method of claim 8, wherein the surface waves are passive surface waves, such that the measurements can be obtained without an active seismic source.

10. The method of claim 6, wherein the geophysical information is obtained for second locations in two or three dimensions.

11. The method of claim 6, wherein the geotechnical information has been obtained using cone penetration testing.

12. The method of claim 6, wherein the geotechnical information comprises at least one of cone resistance, cone wall friction and ground water pressure relative to a respective first location.

13. The method of claim 6, wherein the geotechnical information comprises at least one of ground type or lithology.

14. The method of claim 6, wherein the machine learning model comprises a decision tree model.

15. The method of claim 6, wherein the machine learning model comprises a random forest model.

16. A system comprising:
one or more processors;
one or more memories storing instructions which when executed by the one or more processors, cause the system to:
obtain target data comprising geotechnical information and corresponding first locations at which the geotechnical information was obtained, wherein the geotechnical information was obtained using ground-penetrating apparatus;
obtain input data comprising geophysical information for corresponding one or more second locations within a pre-defined region of each first location, wherein the geophysical information was obtained using a ground surface technique;
apply the input data to a machine learning model to obtain an output of the machine learning model; and
adjust parameters of the machine learning model to reduce an error between the output of the machine learning model and the target data.

17-18. (canceled)

19. The system of claim 16, wherein the input data further comprises a respective rate of change of the geophysical information with respect to depth for each of the corresponding one or more second locations.

20. The system of claim 16, wherein each pre-defined region is defined in terms of maximum distance from a respective first location or maximum distance from a longitudinal axis along which the geotechnical information was obtained at the respective first location.

21. The system of claim 16, wherein the geophysical information for each of the corresponding one or more second locations is weighted with a weight, the weight being determined to decrease with a distance of a respective second location from a respective first location or with a distance from a longitudinal axis along which respective geotechnical information was obtained.

22. The system of claim 16, further comprising instructions when executed by the one or more processors, cause the system to:
obtain an estimate of the geotechnical information at the corresponding first locations using the machine learning model.
